(19) United States
(12) Patent Application Publication
(10) Pub. No.: US 2019/0224624 A1
(43) Pub. Date: Jul. 25, 2019

(54) REVERSE OSMOSIS TREATMENT APPARATUS AND REVERSE OSMOSIS TREATMENT METHOD

(71) Applicant: HITACHI, LTD., Tokyo (JP)

(72) Inventors: Kotaro KITAMURA, Tokyo (JP); Yuichi NAKANO, Tokyo (JP)

(73) Assignee: Hitachi, Ltd., Tokyo (JP)

(21) Appl. No.: 16/319,831

(22) PCT Filed: Feb. 7, 2018
(86) PCT No.: PCT/JP2018/004269

§ 371 Date: Jan. 23, 2019

(30) Foreign Application Priority Data
Feb. 15, 2017 (JP) 2017-026401

(51) Int. Cl. B01D 61/08; B01D 61/02; B01D 61/12; C02F 1/44

(52) U.S. Cl. CPC B01D 61/08; B01D 61/022; B01D 61/12; C02F 1/441; C02F 2103/08; B01D 2317/04; B01D 2317/06; C02F 2209/03; C02F 2209/40; B01D 2313/18

(57) ABSTRACT

A reverse osmosis treatment apparatus includes: a first unit including a plurality of parallel-arranged reverse osmosis membrane modules that perform a primary treatment on water to be treated; and a plurality of second units each including one or more parallel-arranged reverse osmosis membrane modules that perform a subsequent treatment on concentrated water separated at the first unit. Each of the second units includes a concentrated water supply pipe, a concentrated water discharge pipe, a supply pipe valve, and a discharge pipe valve. The concentrated water discharge pipes are connected to the concentrated water supply pipes through a concentrated water return pipe and return pipe valves. A reverse osmosis treatment method includes, after performing subsequent treatments through two or more second units, switching the second unit that performs the subsequent treatment at the last stage.

### BACKGROUND OF THE INVENTION

### 1. Field of the Invention

The present invention relates to a reverse osmosis treatment apparatus for and a reverse osmosis treatment method of desalinating saltwater by multi-stage reverse osmosis treatment.

### 2. Description of the Related Art

In oil drilling fields, various recovery methods are used based on the stage of the recovery. In the primary recovery, underground petroleum is recovered by flush production, utilizing the natural oil discharge energy, or artificial lift, utilizing pumps, gas lift, and so on. Then in the secondary recovery, petroleum left unrecovered in the primary recovery is recovered by water flooding or gas injection. In the tertiary recovery performed after the secondary recovery, the amount of petroleum production is increased by enhanced oil recovery (EOR), such as thermal recovery, miscible flooding, or chemical flooding.

Currently, water flooding is frequently used as a recovery method for the secondary recovery. Water flooding is a recovery method in which highly pressurized water is injected into an underground oil reservoir. In water flooding, water is injected into an oil reservoir to cause petroleum remaining in voids in oil sands and the like to seep into the water. Then, the petroleum seeping into the water is recovered along with the water. In this way, the petroleum recovery rate is improved. Also, by the water injection, the oil discharge energy of a nonflowing oil well can be restored to enable continuous oil recovery.

Water flooding and chemical flooding using aqueous surfactant solution require injection of a large amount of water into an oil reservoir. Thus, the water to be injected is generated from seawater taken from the sea or produced water discharged from the oil well in many cases. If the water to be injected into the oil reservoir contains ions and salts, scale will be deposited in equipment for the injection and the oil reservoir. This makes it difficult to inject the water into the oil reservoir and recover petroleum along with the water. Stopping the water injection directly reduces the amount of petroleum production. Hence, there has been an increasing demand for a technique to efficiently generate a large amount of freshwater from seawater or produced water.

Evaporation, reverse osmosis, electrodialysis, and so on are available as methods of desalinating seawater, produced water, or the like. Among these, reverse osmosis has been widely used for its low operating cost in recent years. Generally, reverse osmosis treatment apparatuses for desalinating saltwater by reverse osmosis include reverse osmosis (RO) membranes or nanofiltration (NF) membranes. For example, JP2003-200160A describes a water generation apparatus in which membrane module units including reverse osmosis membranes or nanofiltration membranes are arranged at a plurality of stages. In such a conventional multi-stage reverse osmosis treatment apparatus, a plurality of reverse osmosis membrane modules are arranged in parallel at each stage, and the water generation capacity is extended by performing treatments through a plurality of lines.

FIG. 9 is a schematic diagram illustrating the configuration of a multi-stage reverse osmosis treatment apparatus according to a comparative example.

As illustrated in FIG. 9, a conventional multi-stage reverse osmosis treatment apparatus (comparative example) 100A generally includes a plurality of units (10A, 20A, 30A) each including a plurality of parallel-arranged reverse osmosis membrane modules M.

In one example, the reverse osmosis treatment apparatus 100A includes a first unit 10A including five reverse osmosis membrane modules M, a second unit 20A including three reverse osmosis membrane modules M, and a third unit 30A including two reverse osmosis membrane modules M.

Generally, the structure of each reverse osmosis membrane module M is such that reverse osmosis membrane elements including reverse osmosis membranes are housed in a pressure vessel. In the reverse osmosis membrane module M, pressurized water to be treated is introduced from one end of the pressure vessel and treated by reverse osmosis treatment by cross-flow filtration. Concentrated water concentrated on the upstream side of the reverse osmosis membranes is discharged from the opposite end of the pressure vessel. On the other hand, the separated permeated water on the downstream side of the reverse osmosis membranes is recovered as desalinated product water.

The reverse osmosis treatment apparatus 100A is configured to perform a primary treatment on the water to be treated with the first unit 10A, a secondary treatment on the concentrated water separated by the primary treatment with the second unit 20A, and a tertiary treatment on the concentrated water separated by the secondary treatment with the third unit 30A. Performing treatments on the concentrated water through a plurality of stages in this manner can raise the recovery rate of permeated water as a whole and therefore increase the amount of product water without having to set the recovery rate of permeated water at each stage at an extremely high rate. Setting the recovery rate at each stage at a low rate suppresses contamination of the reverse osmosis membranes. This can also reduce the frequency of replacement and cleaning of the reverse osmosis membranes and ensure a longer operation time.

In a reverse osmosis membrane module, as concentrated solutes accumulate inside the module, the concentrated solutes are deposited as scale on the surfaces of the reverse osmosis membranes and clog them and may disable stable operation. Thus, for the reverse osmosis membrane module, the lower-limit flow rate (lowest flow rate) of concentrated water to be discharged is often specified in its specifications, and the reverse osmosis membrane module is usually operated to discharge concentrated water at the lower-limit flow rate or higher. Meanwhile, a conventional multi-stage reverse osmosis treatment apparatus is configured such that the number of reverse osmosis membrane modules constituting a unit decreases the more downstream the unit is (see FIG. 9). This configuration, in which the flow rate decreases stepwise with the progression of concentration, ensures a certain flow rate for the concentrated water to be discharged from the unit at the last stage, at which the concentration progresses most.

However, in the conventional multi-stage reverse osmosis treatment apparatus, scale is still prone to build up on the surfaces of the reverse osmosis membranes in the unit at the last stage and the like, and the resultant clogging of the reverse osmosis membranes affects the operation at least in some cases. Moreover, a problem with the conventional multi-stage reverse osmosis treatment apparatus is that, if the water to be treated is pressurized to high pressure in order to maintain a certain flow rate for the concentrated water to be discharged from the unit at the last stage, the operating pressure will be excessively high at the units at preceding stages where the concentration has not progressed much. If the operating pressure at the units at these preceding stages is excessively high, the amount of permeated water separated at the preceding stages will increase. Thus, the contamination of the reverse osmosis membranes will rapidly progress only at the preceding stages. Consequently, the frequency of maintenance of the reverse osmosis membrane modules will increase, and it will be difficult to perform the reverse osmosis treatment at a stable recovery rate of permeated water.

As methods of preventing the build-up of scale, there are a method involving adding scale inhibitor to the water to be treated, as described in JP2003-200160A, a method involving cleaning the surfaces of the reverse osmosis membranes, and so on. However, in the method involving adding scale inhibitor, the cost of the agent is high, and the agent deteriorates the reverse osmosis membranes. Also, in the method involving cleaning the membrane surfaces, the reverse osmosis treatment must be stopped while the cleaning is performed, thereby preventing continuous water generation and reducing the amount of product water.

There has been an increasing demand for a reverse osmosis treatment method capable of suppressing the build-up of scale while also maintaining a high recovery rate of permeated water particularly in recent years. Setting a low recovery rate as a whole may easily ensure a certain flow rate for concentrated water to be discharged from units at downstream stages. Doing so, however, requires performing reverse osmosis treatment on a large amount of water to be treated and performing aftertreatment on a large amount of separated concentrated water in order to generate a target amount of product water. For example, in a case of using product water at an inland oilfield, problems are the transportation cost for transporting seawater taken from the sea to the oilfield and the aftertreatment cost for dewatering the large amount of separated concentrated water to a transportable state and so on. Also, in a case of using product water at an offshore oilfield where floating production, storage, and offloading (FPSO) are performed, a problem is the place to install a large apparatus for generating the target amount of product water.

### SUMMARY OF THE INVENTION

In view of the above, the present invention makes it an object thereof to provide a reverse osmosis treatment apparatus and a reverse osmosis treatment method capable of performing reverse osmosis treatment on saltwater at a high recovery rate by suppressing the build-up of scale.

A reverse osmosis treatment apparatus according to the present invention for solving the above problems includes: a first unit including a plurality of parallel-arranged first reverse osmosis membrane modules that perform a primary treatment on water to be treated; and a plurality of second units each including one or more parallel-arranged second reverse osmosis membrane modules that perform a subsequent treatment on concentrated water separated at the first unit. The second unit includes a concentrated water supply pipe capable of supplying the concentrated water separated at the first unit to the second unit, a concentrated water discharge pipe capable of discharging concentrated water separated at the second unit to outside of the reverse osmosis treatment apparatus, a supply pipe valve capable of stopping the supply of the concentrated water through the concentrated water supply pipe, and a discharge pipe valve capable of stopping the discharge of the concentrated water through the concentrated water discharge pipe. The concentrated water discharge pipes of the plurality of second units are connected to the concentrated water supply pipes of the plurality of second units through a concentrated water return pipe capable of returning and re-supplying the concentrated water discharged from the second units to the second units, and a return pipe valve capable of stopping the return of the concentrated water through the concentrated water return pipe.

Also, a reverse osmosis treatment method according to the present invention is a reverse osmosis treatment method for a reverse osmosis treatment apparatus including a first unit including a plurality of parallel-arranged first reverse osmosis membrane modules that perform a primary treatment on water to be treated; and a plurality of second units each including one or more parallel-arranged second reverse osmosis membrane modules that perform a subsequent treatment on concentrated water separated at the first unit, the reverse osmosis treatment method including: supplying the concentrated water separated at the first unit to some second units among the plurality of second units to thereby perform a subsequent treatment on the concentrated water; returning the concentrated water separated at the second units having performed the subsequent treatment to a remaining second unit among the plurality of second units to thereby perform a further subsequent treatment on the concentrated water; performing the subsequent treatments on the concentrated water separated at the first unit at two or more stages through the plurality of second units; and performing reverse osmosis treatment on the water to be treated while switching the second unit that performs the subsequent treatment at the last stage among the plurality of second units.

According to the present invention, it is possible to provide a reverse osmosis treatment apparatus and a reverse osmosis treatment method capable of performing reverse osmosis treatment on saltwater at a high recovery rate by suppressing the build-up of scale.

### BRIEF DESCRIPTION OF THE DRAWINGS

FIG. 1 is a schematic diagram illustrating the configuration of a reverse osmosis treatment apparatus according to an embodiment of the present invention;

FIG. 2 is a cross-sectional view illustrating an example of the structure of a reverse osmosis membrane module;

FIG. 3 is a perspective view illustrating an example of the structure of a reverse osmosis membrane element;

FIG. 4 is a schematic diagram illustrating a state of flow channels in the reverse osmosis treatment apparatus;

FIG. 5 is a schematic diagram illustrating a state after some flow channels in the reverse osmosis treatment apparatus are switched;

FIG. 6 is a schematic diagram illustrating an example of measuring devices provided to the reverse osmosis treatment apparatus;

FIG. 7 is a schematic diagram illustrating the configuration of a reverse osmosis treatment apparatus according to a first modification of the present invention;

FIG. 8 is a schematic diagram illustrating the configuration of a reverse osmosis treatment apparatus according to a second modification of the present invention; and

FIG. 9 is a schematic view illustrating the configuration of a multi-stage reverse osmosis treatment apparatus according to a comparative example.

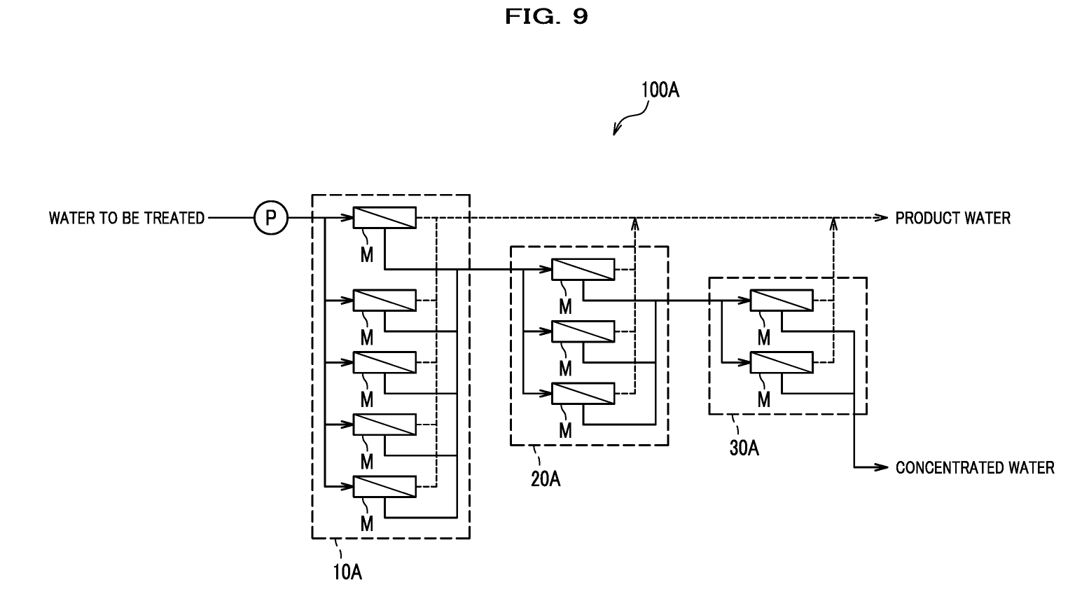

### DETAILED DESCRIPTION OF THE EMBODIMENT

A reverse osmosis treatment apparatus and a reverse osmosis treatment method according to an embodiment of the present invention will be hereinafter described. Note that common components in the following drawings will be denoted by the same reference numeral, and redundant description thereof will be omitted.

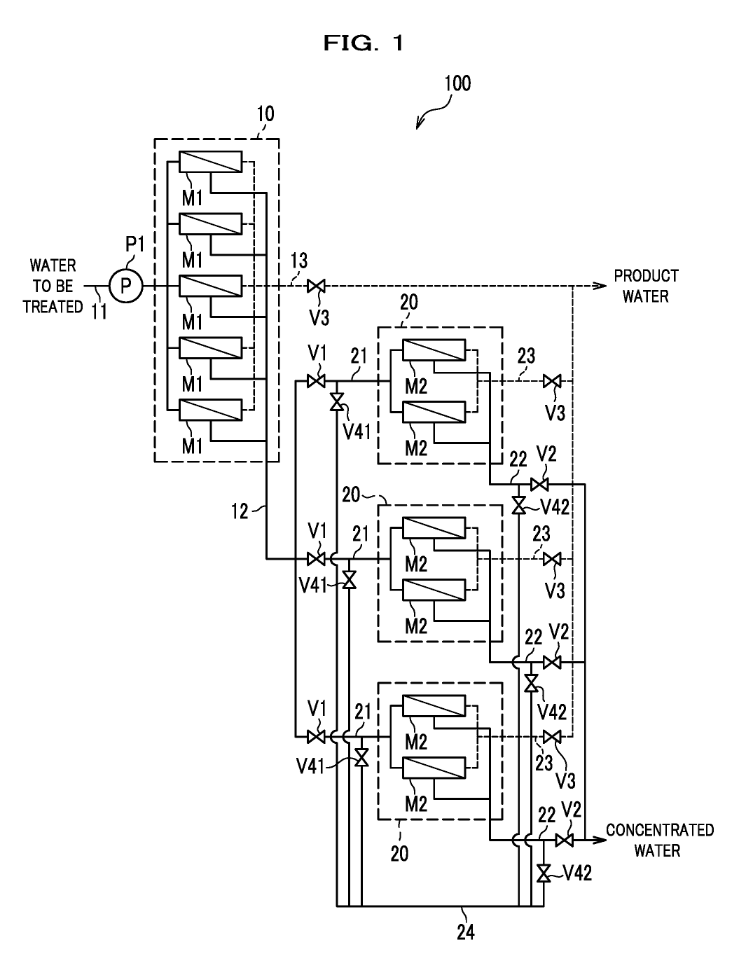

FIG. 1 is a schematic diagram illustrating the configuration of a reverse osmosis treatment apparatus according to an embodiment of the present invention.

As illustrated in FIG. 1, a reverse osmosis treatment apparatus 100 according to this embodiment includes a first unit 10 including reverse osmosis membrane modules M1, a plurality of second units 20 each including reverse osmosis membrane modules M2, a high pressure pump P1, a water to be treated supply pipe 11, a first concentrated water discharge pipe 12, a first permeated water discharge pipe 13, concentrated water supply pipes 21, second concentrated water discharge pipes 22, second permeated water discharge pipes 23, a concentrated water return pipe 24, supply pipe valves V1, discharge pipe valves V2, permeated water flow rate adjustment valves V3, return-pipe outlet valves V41, and return-pipe inlet valves V42.

The reverse osmosis treatment apparatus 100 is an apparatus that performs reverse osmosis treatment on saltwater containing ions and salts with semipermeable membranes to generate freshwater with reduced concentrations of ions and salts. As the saltwater, seawater, produced water, brackish water, fossil water, groundwater, surface water, and the like are usable. The reverse osmosis treatment apparatus 100 can be used for various applications such as desalination of saltwater, such as seawater and produced water, recycling of wastewater, and generation of purified water.

The saltwater as water to be treated is supplied to the reverse osmosis treatment apparatus 100 after being pretreated as appropriate. For example, suspended matters, marine organisms, and so on contained in seawater are removed in advance by coagulating sedimentation treatment using a coagulant, flotation separation treatment, filtration treatment using sand filtration, filter filtration, or the like, sterilization treatment, and so on. Also, oil, organic matters, inorganic matters, and so on contained produced water are removed in advance by coagulating sedimentation treatment, flotation separation treatment, adsorption treatment, and so on.

As illustrated in FIG. 1, the first unit 10 and the second units 20 include a plurality of reverse osmosis membrane modules M1, M2 that desalinate saltwater by reverse osmosis treatment. Now, the structure of the reverse osmosis membrane modules M1, constituting the first unit 10, and the reverse osmosis membrane modules M2, constituting the second unit 20, will be described.

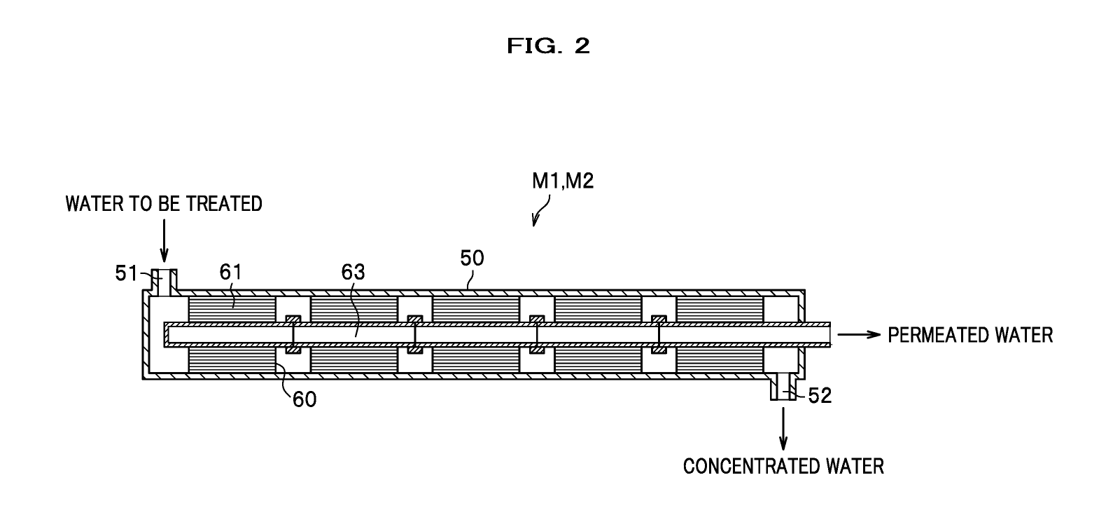

FIG. 2 is a cross-sectional view illustrating an example of the structure of each reverse osmosis membrane module.

As illustrated in FIG. 2, each reverse osmosis membrane module M1, M2 is formed of a pressure vessel 50 and one or more reverse osmosis membrane elements 60. The pressure vessel 50 is a substantially cylindrical vessel and includes an inlet port 51 at one end and an outlet port 52 at the opposite end. One or more reverse osmosis membrane elements 60 are housed in tandem inside the pressure vessel 50.

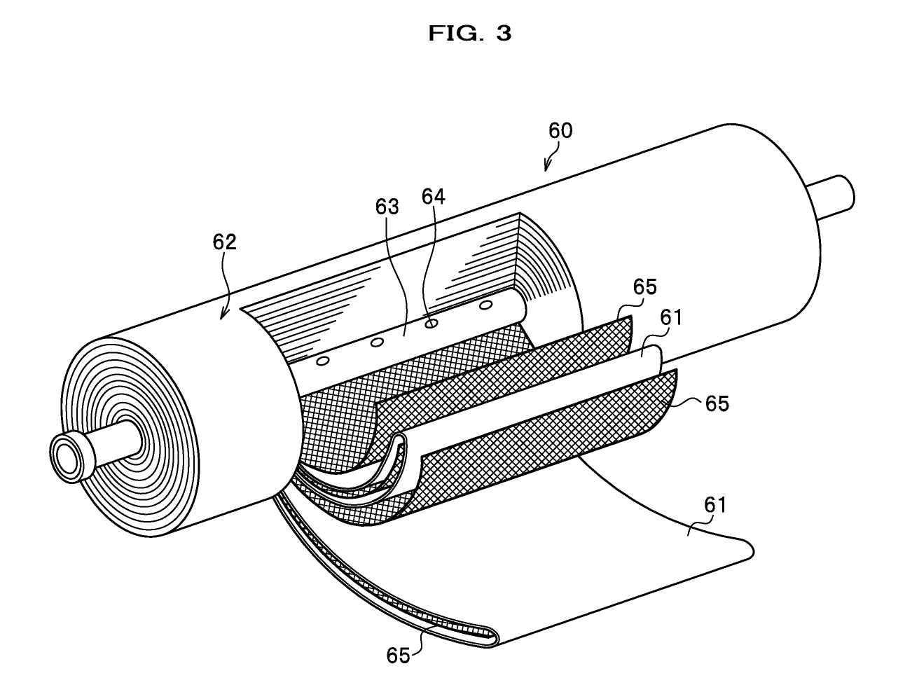

FIG. 3 is a perspective view illustrating an example of the structure of each reverse osmosis membrane element.

As illustrated in FIG. 3, the reverse osmosis membrane element 60 is formed by disposing a membrane unit 62 including reverse osmosis membranes 61 around a water collection pipe 63. The membrane unit 62 is formed by radially joining a plurality of reverse osmosis membranes 61 each in the formed of a bag-shaped body and a plurality of spacers 65 each in the form of mesh to the peripheral surface of the water collection pipe 63 and spirally winding them around the water collection pipe 63. Each reverse osmosis membrane 61 is jointed to the water collection pipe 63 such that the inside of the bag-shaped body communicates with through-holes 64 in the water collection pipe 63. A spacer 65 is placed inside each of the reverse osmosis membranes 61 and between the reverse osmosis membranes 61 to maintain their shapes.

As illustrated in FIG. 2, the reverse osmosis membrane elements 60 are housed in the pressure vessel 50 such that their water collection pipes 63 are arranged in tandem along the longitudinal direction of the pressure vessel 50. The water collection pipes 63 of the reverse osmosis membrane elements 60 are coupled to each other to form a single pipe conduit with an open extremity. The extremity of the water collection pipes 63 is drawn out from the end of the pressure vessel 50 at which the outlet port 52 is provided.

In each reverse osmosis membrane module M1, M2, once the water to be treated pressurized to or above osmotic pressure is introduced into the pressure vessel 50 through the inlet port 51, the water to be treated is treated by reverse osmosis treatment with the reverse osmosis membranes 61 by cross-flow filtration while flowing inside the pressure vessel 50 in its longitudinal direction. Then, the concentrated water concentrated on the upstream side of the reverse osmosis membranes 61 by the reverse osmosis treatment is discharged from inside the pressure vessel 50 through the outlet port 52. On the other hand, the permeated water having permeated the reverse osmosis membranes 61 to the downstream side thereof is collected into the water collection pipe 63 and discharged from the extremity.

The first unit 10 includes the plurality of parallel-arranged reverse osmosis membrane modules M1, which perform primary treatment on the water to be treated, as illustrated in FIG. 1. As the water to be treated is treated by the primary treatment by reverse osmosis, it is separated into first concentrated water with concentrated ions and salts and first permeated water with reduced ions and salts.

The first unit 10 includes reverse osmosis membrane modules M1 with the same specifications. In other words, the plurality of parallel-arranged reverse osmosis membrane modules M1 include pressure vessels 50 of the same type and reverse osmosis membrane elements 60 with the same specifications. The number of reverse osmosis membrane elements 60 housed per pressure vessel 50 is the same for the plurality of reverse osmosis membrane modules M1.

As illustrated in FIG. 1, the first unit 10 includes the water to be treated supply pipe 11, the first concentrated water discharge pipe 12, and the first permeated water discharge pipe 13. Each of the water to be treated supply pipe 11, the first concentrated water discharge pipe 12, and the first permeated water discharge pipe 13 and each reverse osmosis membrane module M1, constituting the first unit 10, are connected to each other through a pipe conduit.

One end of the water to be treated supply pipe 11 is connected to the first unit 10 and connected to the inlet port 51 (see FIG. 2) of each reverse osmosis membrane module M1, constituting the first unit 10. The water to be treated supply pipe 11 forms a flow channel for supplying the water to be treated to the first unit 10 from a pretreatment installation not illustrated or the like. The high pressure pump P1, which pressures the water to be treated to high pressure to supply it, is installed on the water to be treated supply pipe 11. The water to be treated is pressurized to or above the osmotic pressure by the high pressure pump P1, split and introduced into the reverse osmosis membrane modules M1, and treated by the primary treatment there.

One end of the first concentrated water discharge pipe 12 is connected to the first unit 10 and connected to the outlet port 52 (see FIG. 2) of each reverse osmosis membrane module M1. Moreover, the opposite end is connected to the concentrated water supply pipes 21, provided respectively to the plurality of second units 20. The first concentrated water discharge pipe 12 forms a flow channel for discharging the first concentrated water separated at the first unit 10 from the first unit 10 into the second units 20. The first concentrated water is discharged from each reverse osmosis membrane module M1, merges with the others at the first concentrated water discharge pipe 12, and is delivered to the second units 20 through the first concentrated water discharge pipe 12.

One end of the first permeated water discharge pipe 13 is connected to the first unit 10 and connected to the water collection pipe 63 (see FIG. 2) drawn from each reverse osmosis membrane module M1. Moreover, the opposite end is connected to the outside of the reverse osmosis treatment apparatus 100. The first permeated water discharge pipe 13 forms a flow channel capable of discharging the first permeated water separated at the first unit 10 from the first unit 10 to the outside of the reverse osmosis treatment apparatus 100. The first permeated water is discharged from each reverse osmosis membrane module M1, merges with the others at the first permeated water discharge pipe 13, is delivered to the outside of the reverse osmosis treatment apparatus 100 through the first permeated water discharge pipe 13, and recovered as product water.

A permeated water flow rate adjustment valve V3, which changes the flow rate of the permeated water to adjust the pressure inside the pressure vessels 50, is installed on the first permeated water discharge pipe 13. The operating pressure of each reverse osmosis membrane module M1 is adjusted by adjusting the opening degree of the permeated water flow rate adjustment valve V3 on the first permeated water discharge pipe 13.

As illustrated in FIG. 1, each second unit 20 includes a plurality of parallel-arranged reverse osmosis membrane modules M2, which perform a subsequent treatment on the first concentrated water separated at the first unit 10. As the first concentrated water separated at the first unit 10 is treated by the subsequent treatment by reverse osmosis, it is separated into second concentrated water with further concentrated ions and salts and second permeated water with further reduced ions and salts.

There are a plurality of second units 20, and each second unit 20 includes reverse osmosis membrane modules M2 with the same specifications. In other words, the plurality of parallel-arranged reverse osmosis membrane modules M2 in all second units 20 include pressure vessels 50 of the same type and reverse osmosis membrane elements 60 with the same specifications. The number of reverse osmosis membrane elements 60 housed per pressure vessel 50 is the same for the plurality of reverse osmosis membrane modules M2.

As illustrated in FIG. 1, each second unit 20 includes a concentrated water supply pipe 21, a second concentrated water discharge pipe 22, and a second-permeated water discharge pipe 23. The plurality of second units 20 include their respective concentrated water supply pipes 21, second concentrated water discharge pipes 22, and second permeated water discharge pipes 23. Each of the concentrated water supply pipe 21, the second concentrated water discharge pipe 22, and the second permeated water discharge pipe 23 of each second unit 20 and each reverse osmosis membrane module M2 constituting the second unit 20 are connected to each other through a pipe conduit.

One end of each concentrated water supply pipe 21 is connected to the first concentrated water discharge pipe 12. Moreover, the opposite end is connected to the inlet port 51 (see FIG. 2) of each reverse osmosis membrane module M2 constituting the corresponding second unit 20. The concentrated water supply pipe 21 forms a flow channel capable of supplying the first concentrated water separated at the first unit 10 from the first unit 10 into the second unit 20. The first concentrated water is pressurized to or above the osmotic pressure and supplied to predetermined one or ones of the second units 20, split and introduced into their reverse osmosis membrane modules M2, and treated by a subsequent treatment there.

A supply pipe valve V1, capable of stopping the supply of the first concentrated water through the concentrated water supply pipe 21, is installed on the concentrated water supply pipe 21. When the supply pipe valve V1, capable of being opened and closed, is closed, the first concentrated water is not introduced into the reverse osmosis membrane modules M2.

One end of each second concentrated water discharge pipe 22 is connected to the corresponding second unit 20 and connected to the outlet port 52 (see FIG. 2) of each of its reverse osmosis membrane modules M2. Moreover, the opposite end is connected to the outside of the reverse osmosis treatment apparatus 100. The second concentrated water discharge pipe 22 forms a flow channel capable of discharging the second concentrated water separated at the second unit 20 from the second unit 20 to the outside of the reverse osmosis treatment apparatus 100. The second concentrated water is discharged from each reverse osmosis membrane module M2, merges with the others at the second concentrated water discharge pipe 22, is delivered to the outside of the reverse osmosis treatment apparatus 100 through the second concentrated water discharge pipe 22, and treated by aftertreatment or the like.

A discharge pipe valve V2, capable of stopping the discharge of the second concentrated water through the second concentrated water discharge pipe 22, is installed on the second concentrated water discharge pipe 22. When the discharge pipe valve V2, capable of being opened and closed, is closed, the second concentrated water is not discharged to the outside of the reverse osmosis treatment apparatus 100.

One end of each second permeated water discharge pipe 23 is connected to the corresponding second unit 20 and connected to the water collection pipe 63 (see FIG. 2) drawn from each of its reverse osmosis membrane modules M2. Moreover, the opposite end is connected to the outside of the reverse osmosis treatment apparatus 100. The second permeated water discharge pipe 23 forms a flow channel capable of discharging the second permeated water separated at the second unit 20 from the second unit 20 to the outside of the reverse osmosis treatment apparatus 100. The second permeated water is discharged from each reverse osmosis membrane module M2, merges with the others at the second permeated water discharge pipe 23, is delivered to the outside of the reverse osmosis treatment apparatus 100 through the second permeated water discharge pipe 23, and recovered as product water.

A permeated water flow rate adjustment valve V3, which changes the flow rate of the permeated water to adjust the pressure inside the pressure vessels 50, is installed on the second permeated water discharge pipe 23. The operating pressure of each reverse osmosis membrane module M2 is adjusted by adjusting the opening degree of the permeated water flow rate adjustment valve V3 on the second permeated water discharge pipe 23.

As illustrated in FIG. 1, the second concentrated water discharge pipes 22 of the plurality of second units 20 are connected to the concentrated water supply pipes 21 of the plurality of second units 20 through the concentrated water return pipe 24, the return-pipe outlet valves V41, and a return-pipe inlet valve V42.

One end of the concentrated water return pipe 24 is connected to the outlet ports 52 (see FIG. 2) of all reverse osmosis membrane modules M2 constituting the second units 20. Moreover, the opposite end is connected to the inlet ports 51 (see FIG. 2) of all reverse osmosis membrane modules M2 constituting the second units 20. The concentrated water return pipe 24 forms flow channels capable of returning and re-supplying the second concentrated water separated at the second units 20 and discharged from the second units 20 to any second units 20. The second concentrated water is discharged from each reverse osmosis membrane module M2, merges with the others at the concentrated water return pipe 24, is returned to any second units 20 through the concentrated water return pipe 24, and can be treated by a further subsequent treatment at the second and following stages.

Each return-pipe outlet valve V41 is connected between the concentrated water return pipe 24 and one of the concentrated water supply pipes 21 for supplying the first concentrated water separated at the first unit 10 to the corresponding second unit 20. One return-pipe outlet valve V41 is provided for each second unit 20 and capable of stopping the return of the second concentrated water through the concentrated water return pipe 24 to the second unit 20. When the return-pipe outlet valve V41, capable of being opened and closed, is closed, the second concentrated water is not returned to that second units 20.

Each return-pipe inlet valve V42 is connected between the concentrated water return pipe 24 and one of the second concentrated water discharge pipes 22 for discharging the second concentrated water separated at the corresponding second units 20. One return-pipe inlet valve V42 is provided for each second unit 20 and capable of stopping the return of the second concentrated water through the concentrated water return pipe 24 to any second units 20. When the return-pipe inlet valve V42, capable of being opened and closed, is closed, the second concentrated water is not returned to any second units 20.

Next, a reverse osmosis treatment method using the reverse osmosis treatment apparatus 100 will be specifically described.

In the reverse osmosis treatment using the reverse osmosis treatment apparatus 100, the opening and closing of valves are switched to form a series of flow channels along which the first concentrated water separated at the first unit 10 passes through two or more second units 20. The first concentrated water separated by the primary treatment at the first unit 10 is further treated by subsequent treatments at two or more stages through the two or more second units 20.

Also, in the reverse osmosis treatment using the reverse osmosis treatment apparatus 100, the series of flow channels running through the two or more second units 20 are changed each time a predetermined period of time elapses or each time a predetermined state occurs, to thereby continue the reverse osmosis treatment on the water to be treated. When the flow channels are changed during operation of the reverse osmosis treatment apparatus 100, the second unit 20 that performs the subsequent treatment at the last stage among the subsequent treatments at the two or more stages is switched among the plurality of second units 20. This prevents local progression of the build-up of scale and the contamination of the reverse osmosis membranes.

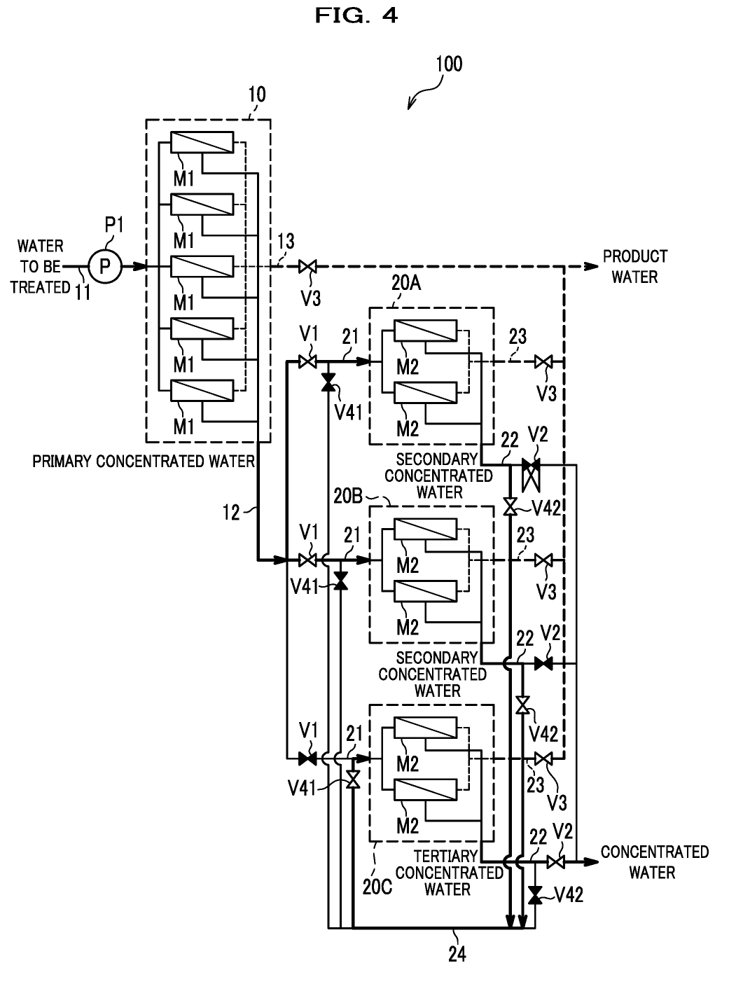

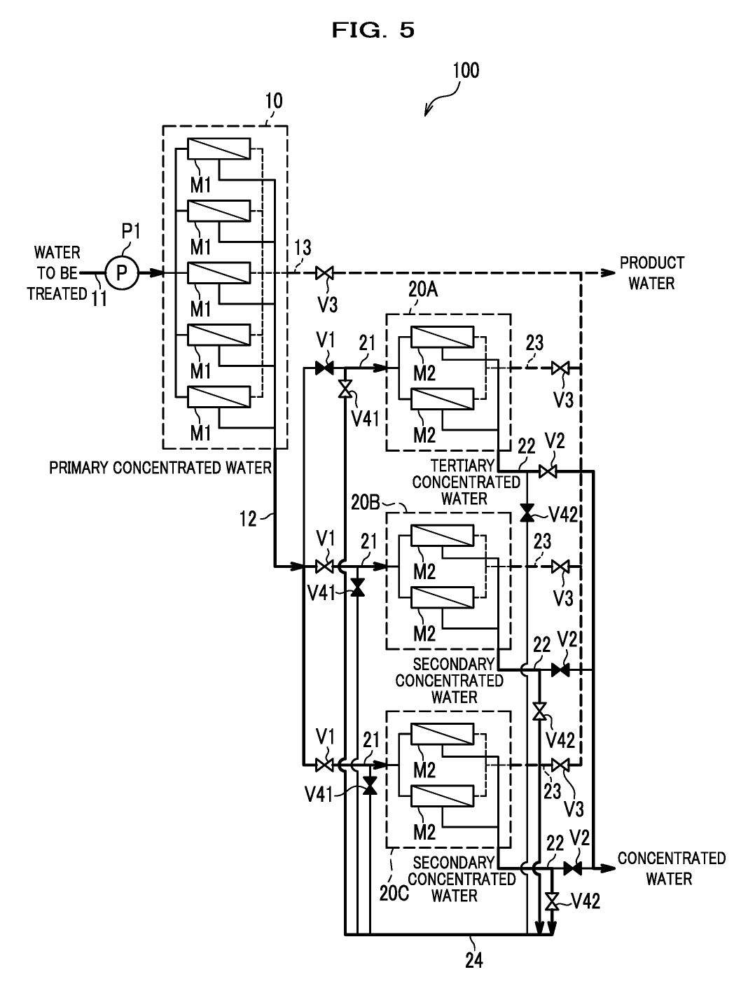

FIG. 4 is a schematic diagram illustrating a state of the flow channels in the reverse osmosis treatment apparatus. Also, FIG. 5 is a schematic diagram illustrating a state after some flow channels in the reverse osmosis treatment apparatus are switched.

In FIGS. 4 and 5, each bold line represents the flow of the water to be treated or the concentrated water. Also, each black valve represents a closed valve while each white valve represents an opened valve.

FIG. 4 exemplarily illustrates a state where, among the plurality of (three) second units 20, some (two) second units 20A, 20B are assigned with the subsequent treatment at the upstream stage (secondary treatment) whereas the remaining (one) second unit 20C is assigned with the subsequent treatment at the last stage (tertiary treatment). Also, FIG. 5 exemplarily illustrates a state where the unit that performs the subsequent treatment at the last stage (tertiary treatment) has been switched to the second unit 20A, and the units that perform the subsequent treatment at the upstream stage (secondary treatment) have been switched to the second units 20B, 20C.

As illustrated in FIG. 4, in the reverse osmosis treatment using the reverse osmosis treatment apparatus 100, the supply pipe valves V1 of some second units 20A, 20B among the plurality of second units 20 are opened and their discharge pipe valves V2 are closed when the water to be treated is treated by the reverse osmosis treatment. Moreover, their return-pipe inlet valves V42 are opened and their return-pipe outlet valves V41 are closed. Switching the opening and closing of the valves in this way forms flow channels to which only the first concentrated water (primary concentrated water) is supplied and flow channels through which the second concentrated water (secondary concentrated water) separated by a subsequent treatment (secondary treatment) is only returned for some second units 20A, 20B.

On the other hand, the supply pipe valve V1 of the remaining second unit 20C among the plurality of second units 20 is closed and its discharge pipe valve V2 is opened. Moreover, its return-pipe inlet valve V42 is closed and its return-pipe outlet valve V41 is opened. Switching the opening and closing of the valves in this way forms a flow channel to which only the returned second concentrated water (secondary concentrated water) is supplied and a flow channel through which the second concentrated water (tertiary concentrated water) separated by a further subsequent treatment (tertiary treatment) is discharged to only the outside of the reverse osmosis treatment apparatus 100 for the remaining second unit 20C.

Once the opening and closing of the valves are switched, the first unit 10 performs the primary treatment on the water to be treated supplied thereto, some second units 20A, 20B among the plurality of second units 20 perform a subsequent treatment (secondary treatment) on the first concentrated water supplied thereto through the respective concentrated water supply pipes 21, and the remaining second unit 20C among the plurality of second units 20 performs a further subsequent treatment (tertiary treatment) on the second concentrated water returned thereto from the second units 20A, 20B having performed their subsequent treatment through the concentrated water return pipe 24.

In the reverse osmosis treatment using the reverse osmosis treatment apparatus 100, the second unit 20 that performs the subsequent treatment at the last stage among the subsequent treatments at the two or more stages is switched among the plurality of second units 20 during operation of the reverse osmosis treatment apparatus 100 based on, for example, the cumulative time of the subsequent treatment since the start of introduction of the concentrated water to the reverse osmosis membrane modules M2, the integrated flow rate of the concentrated water or the permeated water discharged from the reverse osmosis membrane modules M2, the transmembrane pressure in the reverse osmosis membrane modules M2, quality of the permeated water discharged from the reverse osmosis membrane modules M2, and/or the like.

As illustrated in FIG. 5, to switch the unit that performs the subsequent treatment at the last stage to the second unit 20A, the supply pipe valves V1 of some second units 20B, 20C among the plurality of second units 20 are opened and their discharge pipe valves V2 are closed. Moreover, their return-pipe inlet valves V42 are opened and their return-pipe outlet valves V41 are closed.

Switching the opening and closing of the valves in this way forms flow channels to which only the first concentrated water (primary concentrated water) is supplied and flow channels through which the second concentrated water (secondary concentrated water) separated by a subsequent treatment (secondary treatment) is only returned for some second units 20B, 20C.

On the other hand, the supply pipe valve V1 of the remaining second unit 20A among the plurality of second units 20 is closed and its discharge pipe valve V2 is opened. Moreover, its return-pipe inlet valve V42 is closed and its return-pipe outlet valve V41 is opened. Switching the opening and closing of the valves in this way forms a flow channel to which only the returned second concentrated water (secondary concentrated water) is supplied and a flow channel through which the second concentrated water (tertiary concentrated water) separated by a further subsequent treatment (tertiary treatment) is discharged to the outside of the reverse osmosis treatment apparatus 100 for the remaining second unit 20A.

Once the opening and closing of the valves are switched, the first unit 10 performs the primary treatment on the water to be treated supplied thereto, some second units 20B, 20C among the plurality of second units 20 perform a subsequent treatment (secondary treatment) on the first concentrated water supplied thereto through the respective concentrated water supply pipes 21, and the remaining second unit 20A among the plurality of second units 20 performs a further subsequent treatment (tertiary treatment) on the second concentrated water returned thereto from the second units 20B, 20C having performed their subsequent treatment through the concentrated water return pipe 24.

In the reverse osmosis treatment using the reverse osmosis treatment apparatus 100, the operating pressure at the first unit 10 can be adjusted with the permeated water flow rate adjustment valve V3 on the first permeated water discharge pipe 13. Moreover, the operating pressure at each second unit 20 can be adjusted with the permeated water flow rate adjustment valve V3 on its second permeated water discharge pipe 23. In other words, with the permeated water flow rate adjustment valves V3, which are provided not on the concentrated water side but on the permeated water side, it is possible to maintain a certain flow rate for the concentrated water discharged from each reverse osmosis membrane module M1, M2 while also adjusting the operating pressure of the reverse osmosis membrane module M1, M2.

Generally, in a multi-stage reverse osmosis treatment apparatus that performs reverse osmosis treatment on water to be treated pressurized to high pressure, the more downstream the unit is, the further the concentration progresses and the higher the osmotic pressure is, and the osmotic pressure is highest at the unit at the last stage. For this reason, a necessary reverse osmotic pressure needs to be applied to the water to be treated based on the unit at the last stage.

Also, in each reverse osmosis membrane module, the closer it is to the outlet side from the inlet side, the further the concentration progresses and the more the calcium, magnesium, sulfate ion, carbonate ion, silica, and so on contained in the water to be treated are accumulated and deposited as scale. For this reason, a pressure needs to be applied based on the reverse osmosis membrane element on the outlet side such that concentrated water will be discharged at a predetermined lower-limit flow rate from the reverse osmosis membrane module.

Generally, however, if the operating pressure is set based on the reverse osmosis membrane element on the outlet side in the unit at the last stage, the closer the reverse osmosis membrane element is to the inlet side in an upstream unit at which the concentration has not progressed much, the larger the difference between the necessary reverse osmotic pressure and the set operating pressure. Consequently, the closer the reverse osmosis membrane element is to the inlet side in the upstream unit, the greater the amount of separated permeated water exceeds the designed amount. Thus, the more upstream the reverse osmosis membranes are, the further their contamination progresses.

In contrast, the recovery rate can be reduced by lowering the operating pressure of the reverse osmosis membrane modules M1, M2 with the permeated water flow rate adjustment valves V3. In this way, it is possible to reduce the difference in pressure between the first unit 10 and the second units 20 and the difference in pressure between the inlet side and the outlet side in the reverse osmosis membrane modules M1, M2. This makes it possible to suppress local progression of the contamination of the reverse osmosis membranes on the upstream side. Moreover, with the permeated water side adjusted, discharged concentrated water is treated by subsequent treatment on the downstream side while its flow rate is maintained at a certain rate. In this way, it is possible to easily ensure a certain amount of product water as a whole. It is also possible to stop the discharge of the permeated water and discharge the solutes staying in the reverse osmosis membrane modules M1, M2 by causing water to pass therethrough.

In the reverse osmosis treatment using the reverse osmosis treatment apparatus 100 in particular, preferably, the operating pressure of the reverse osmosis membrane modules M2 of the second units 20 that perform the subsequent treatment at the stage preceding the last stage among the subsequent treatments at the two or more stages, is adjusted with their respective permeated water flow rate adjustment valves V3, which are provided on the permeated water side. The quality and flow rate of the water to be introduced into a second unit 20 can be different between when the second unit 20 is assigned with the upstream subsequent treatment and when the second unit 20 is assigned with the downstream subsequent treatment. However, with the configuration in which the operating pressure of the reverse osmosis membrane modules M2 is adjusted with their permeated water flow rate adjustment valves V3, stable subsequent treatments can be continued even when the assignment is switched.

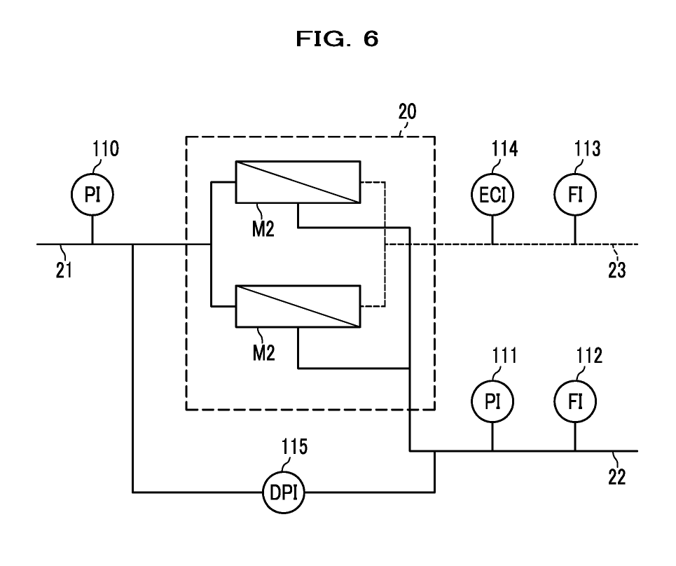

FIG. 6 is a schematic diagram illustrating an example of measuring devices provided to the reverse osmosis treatment apparatus.

As illustrated in FIG. 6, in the reverse osmosis treatment apparatus 100, one or more inlet side pressure sensors 110, an outlet side pressure sensor 111, a concentrated water flow rate sensor 112, a permeated water flow rate sensor 113, an electric conductivity sensor 114, and a pressure difference sensor 115 can be installed for each of the plurality of second units 20.

The inlet side pressure sensor 110 can be installed on the concentrated water supply pipe 21 to measure the pressure on the inlet side of the reverse osmosis membrane modules M2. Also, the outlet side pressure sensor 111 can be installed on the second concentrated water discharge pipe 22 to measure the pressure on the outlet side of the reverse osmosis membrane modules M2. Also, the pressure difference sensor 115 can be installed between the concentrated water supply pipe 21 and the second concentrated water discharge pipe 22 to measure the difference between the pressures on the inlet side and the outlet side of the reverse osmosis membrane modules M2.

The concentrated water flow rate sensor 112 can be installed on the second concentrated water discharge pipe 22 to measure the flow rate of the second concentrated water discharged from the reverse osmosis membrane modules M2. Also, the permeated water flow rate sensor 113 can be installed on the second permeated water discharge pipe 23 to measure the flow rate of the second permeated water discharged from the reverse osmosis membrane modules M2. Also, the electric conductivity sensor 114 can be installed on the second permeated water discharge pipe 23 to measure the electric conductivity of the second permeated water discharged from the reverse osmosis membrane modules M2. The quality of the second permeated water, i.e., the concentration of ions and salts can be figured out based on the electric conductivity.

The one or more inlet side pressure sensors 110, the outlet side pressure sensor 111, the concentrated water flow rate sensor 112, the permeated water flow rate sensor 113, the electric conductivity sensor 114, and the pressure difference sensor 115 can be used to determine the timing to change flow channels. By automatically or manually switching the opening and closing of valves based on the measurements by these devices, a series of flow channels running through two or more second units 20 can be timely changed each time a predetermined state occurs.

Specifically, flow channels may be changed based on the measurements by the inlet side pressure sensor 110, the outlet side pressure sensor 111, and the pressure difference sensor 115 when the pressures on the inlet side and the outlet side of the reverse osmosis membrane modules M2 reach predetermined values, the difference between these pressures reaches a predetermined value, or a predetermined time rate of change is reached. In this way, the operating pressures at the second units 20 are uniformed. Consequently, it is possible to prevent the occurrence of local contamination and local application of a pressure load on the inlet side of the reverse osmosis membrane modules M2, as well as progression of the build-up of scale on the outlet side of the reverse osmosis membrane modules M2.

Also, flow channels may be changed based on the measurement by the concentrated water flow rate sensor 112 when the integrated flow rate of the second concentrated water or the second permeated water falls below a predetermined value planned in advance. In this way, the recovery rate at each second unit 20 is maintained at a certain rate. Consequently, it is possible to maintain the amount of product water at the target level.

Also, flow channels may be changed based on the measurement by the electric conductivity sensor 114 when the electric conductivity of the second permeated water exceeds a predetermined value set in advance. In this way, the removal rates at the second units 20 are uniformed. Consequently, it is possible to prevent the occurrence of local contamination and local application of a pressure load in the reverse osmosis membrane modules M2, as well as progression of the build-up of scale.

Alternatively, the one or more inlet side pressure sensors 110, the outlet side pressure sensor 111, the concentrated water flow rate sensor 112, the permeated water flow rate sensor 113, the electric conductivity sensor 114, and the pressure difference sensor 115 can be used to control the opening degree of the permeated water flow rate adjustment valve V3. A stable subsequent treatment can be continued by controlling the permeated water flow rate adjustment valve V3 such that the flow rate of the second concentrated water, the flow rate of the second permeated water, the pressure on the inlet side of the reverse osmosis membrane modules M2, the pressure on the outlet side of the reverse osmosis membrane modules M2, the electric conductivity of the second permeated water, and so on will be at predetermined values.

According to the above-described reverse osmosis treatment apparatus 100 and reverse osmosis treatment method, the water to be treated is treated by the reverse osmosis treatment while the second unit 20 that performs the subsequent treatment at the last stage among the subsequent treatments at the two or more stages is switched among the plurality of second units 20. In this way, the second unit 20 assigned with the subsequent treatment at the last stage can be caused to perform the subsequent treatment at the preceding stage, at which the concentration has not progressed much. Generally, scale generated in reverse osmosis treatment clogs the reverse osmosis membranes and the like by developing on small deposition cores. The small deposition cores are generated when the concentration of solutes progresses close to the saturation solubility. However, they can be resolved again and disappear in dilute water in which the concentration has not progressed much, or can be easily discharged along with the concentrated water. This means that, by causing the second unit 20 assigned with the subsequent treatment at the last stage to perform the subsequent treatment at the preceding stage before the build-up of scale progresses, deposition cores that can possibly accumulate in that second unit 20 can be eliminated with dilute concentrated water. Thus, a high recovery rate can be set. In addition, the usage life of the reverse osmosis membrane modules is prolonged, so that the water generation can be seamlessly continued without stopping the operation for maintenance, cleaning, and the like of the reverse osmosis membrane modules M1, M2. Hence, according to the above-described reverse osmosis treatment apparatus 100 and reverse osmosis treatment method, it is possible to perform reverse osmosis treatment on saltwater at a high recovery rate by suppressing the build-up of scale.

Next, reverse osmosis treatment apparatuses and reverse osmosis treatment methods according modifications of the present invention will be described.

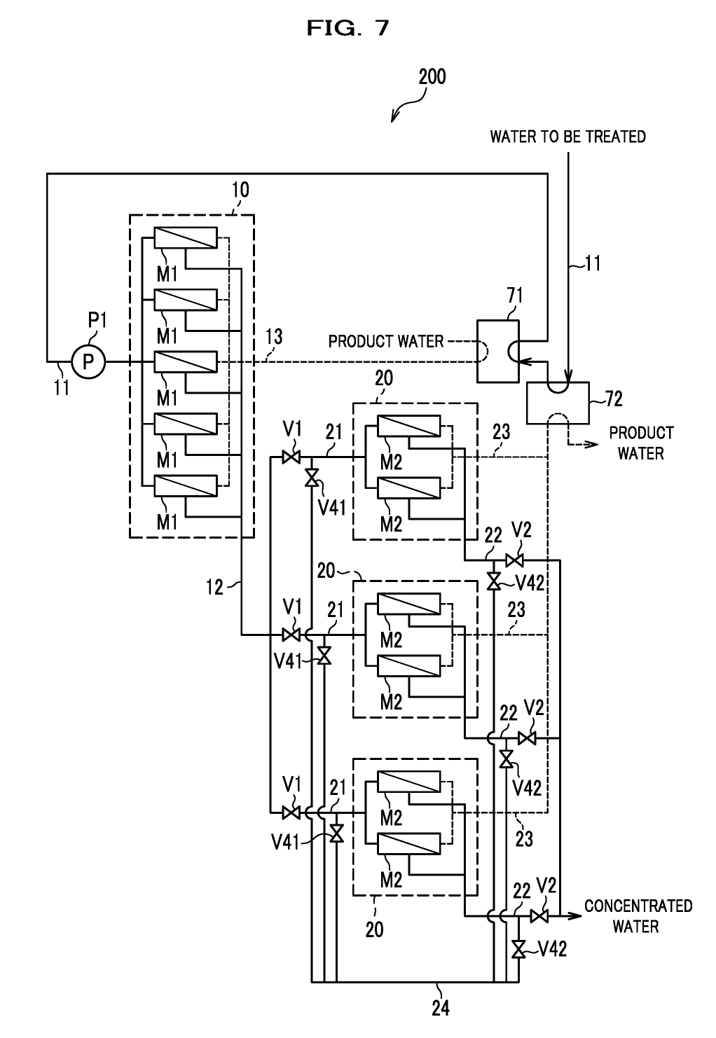

FIG. 7 is a schematic diagram illustrating the configuration of a reverse osmosis treatment apparatus according to a first modification of the present invention. As illustrated in FIG. 7, a reverse osmosis treatment apparatus 200 according to the first modification includes the first unit 10, the second units 20, the high pressure pump P1, the water to be treated supply pipe 11, the first concentrated water discharge pipe 12, the first permeated water discharge pipe 13, the concentrated water supply pipe 21, the second concentrated water discharge pipe 22, the second permeated water discharge pipe 23, the concentrated water return pipe 24, the supply pipe valve V1, the discharge pipe valve V2, the return-pipe outlet valve V41, and the return-pipe inlet valve V42, as in the above-described reverse osmosis treatment apparatus 100.

The reverse osmosis treatment apparatus 200 according to the first modification differs from the above-described reverse osmosis treatment apparatus 100 in that the reverse osmosis treatment apparatus 200 according to the first modification includes a first energy recovery device 71 that recovers energy of the first permeated water discharged by the first unit 10 and a second energy recovery device 72 that recovers energy of the second permeated water discharged by each second unit 20, in place of the permeated water flow rate adjustment valves V3. Specifically, the energy recovery devices 71, 72 include a device capable of exchanging energy such as pressure or flow velocity, such as a pressure exchanger of a PX (Pressure Exchanger) type, a DWEER (Dual Work Energy Exchanger) type, or the like, an energy exchanger of a turbocharger type, or a Pelton wheel.

The first energy recovery device 71 is connected to the water to be treated supply pipe 11 and the first permeated water discharge pipe 13 and supplied with the first permeated water discharged from the reverse osmosis membrane module M1 and the water to be treated. As the energy of the first permeated water discharged through the first permeated water discharge pipe 13 is recovered by the first energy recovery device 71, that energy is applied to the water to be treated supplied through the water to be treated supply pipe 11 and thereby pressurizes the water to be treated.

The second energy recovery device 72 is connected to the water to be treated supply pipe 11 and each of the second permeated water discharge pipes 23 of the plurality of second units 20 and supplied with the second permeated water discharged from the reverse osmosis membrane modules M2 and the water to be treated. As the energy of the second permeated water discharged through the second permeated water discharge pipes 23 is recovered by the second energy recovery device 72, that energy is applied to the water to be treated supplied through the water to be treated supply pipe 11 and thereby pressurizes the water to be treated.

In the reverse osmosis treatment using the reverse osmosis treatment apparatus 200, the first unit 10 performs the primary treatment on the water to be treated supplied thereto while being pressurized by the energy recovery devices 71, 72, some second units 20 among the plurality of second units 20 perform a subsequent treatment (secondary treatment) on the first concentrated water supplied thereto through the respective concentrated water supply pipes 21, and the remaining second unit 20 among the plurality of second units 20 performs a further subsequent treatment (tertiary treatment) on the second concentrated water returned thereto from the second units 20 having performed their subsequent treatment through the concentrated water return pipe 24. Then, the permeated water discharged by the first unit 10 and the second unit 20 is supplied to the energy recovery devices 71, 72 and its energy is recovered. Thereafter, the reverse osmosis treatment on the water to be treated and the energy recovery are continued while the second unit 20 that performs the subsequent treatment at the last stage among the subsequent treatments at the two or more stages is switched among the plurality of second units 20.

According to the above-described reverse osmosis treatment apparatus 200 and reverse osmosis treatment method, the pressure energy of the permeated water separated by the reverse osmosis treatment can be reused to pressurize the water to be treated. This improves the energy efficiency of the reverse osmosis treatment and enables the reverse osmosis treatment to be performed continuously at a low power cost. Note that the energy recovery devices 71, 72 may be mechanically coupled directly to the high pressure pump P1 by shaft mechanisms, and supply the energy recovered from the permeated water directly to the high pressure pump P1. Alternatively, the energy recovery devices 71, 72 may convert the energy recovered from the permeated water into electricity and supply it to the high pressure pump P1, the various valves, and so on.

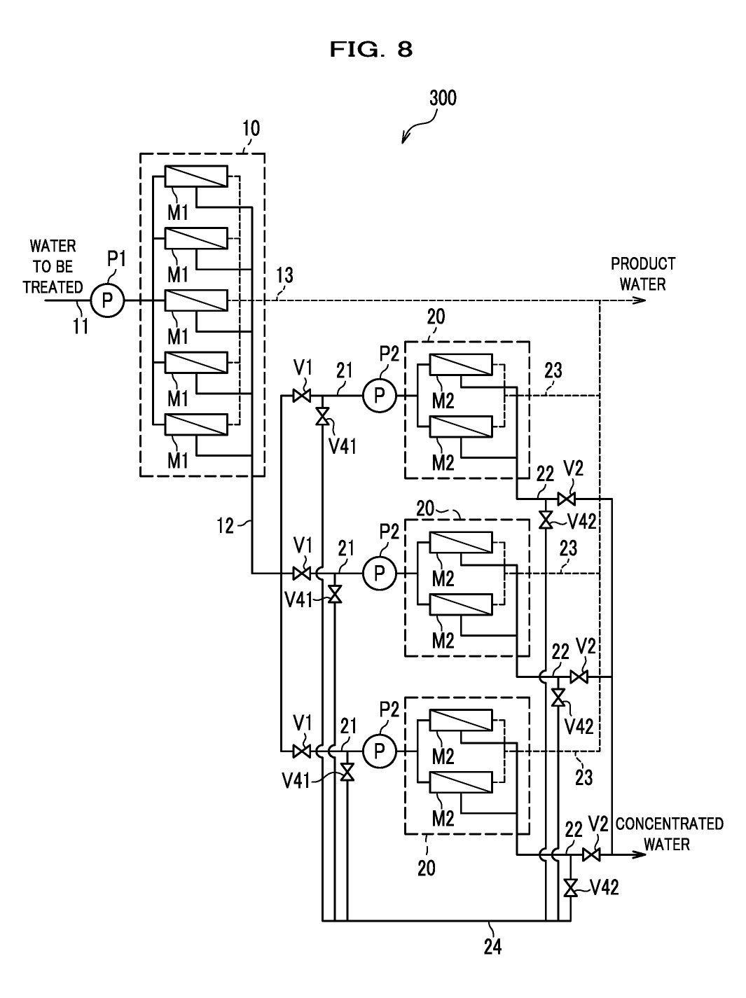

FIG. 8 is a schematic diagram illustrating the configuration of a reverse osmosis treatment apparatus according to a second modification of the present invention.

As illustrated in FIG. 8, a reverse osmosis treatment apparatus 300 according to the second modification includes the first unit 10, the second units 20, the high pressure pump P1, the water to be treated supply pipe 11, the first concentrated water discharge pipe 12, the first permeated water discharge pipe 13, the concentrated water supply pipe 21, the second concentrated water discharge pipe 22, the second permeated water discharge pipe 23, the concentrated water return pipe 24, the supply pipe valve V1, the discharge pipe valve V2, the return-pipe outlet valve V41, and the return-pipe inlet valve V42, as in the above-described reverse osmosis treatment apparatus 100.

The reverse osmosis treatment apparatus 300 according to the second modification differs from the above-described reverse osmosis treatment apparatus 100 in that the reverse osmosis treatment apparatus 300 according to the second modification includes concentrated water pumps P2 that pressurize concentrated water to supply it to the second units 20, in place of the permeated water flow rate adjustment valves V3. The concentrated water pumps P2 are inverter-driven booster pumps capable of adjusting the amount of ejection, for example.

The concentrated water pumps P2 are installed on the concentrated water supply pipes 21 of the plurality of second units 20, and one concentrated water pump P2 is provided for each of the plurality of second units 20. The first concentrated water supplied through the concentrated water supply pipes 21 and the second concentrated water returned through the concentrated water return pipe 24 to be re-supplied are pressurized to or above the osmotic pressure by the concentrated water pumps P2, and split and introduced into the reverse osmosis membrane modules M2.

In the reverse osmosis treatment using the reverse osmosis treatment apparatus 300, the first unit 10 performs the primary treatment on the water to be treated pressurized and supplied thereto by the high pressure pump P1, some second units 20 among the plurality of second units 20 perform a subsequent treatment (secondary treatment) on the first concentrated water pressurized and supplied thereto by the concentrated water pumps P2, and the remaining second unit 20 among the plurality of second units 20 performs a further subsequent treatment (tertiary treatment) on the second concentrated water returned thereto from the second units 20 having performed their subsequent treatment through the concentrated water return pipe 24 and pressurized and re-supplied by the corresponding concentrated water pump P2. Thereafter, the reverse osmosis treatment on the water to be treated is continued while the second unit 20 that performs the subsequent treatment at the last stage among the subsequent treatments at the two or more stages is switched among the plurality of second units 20.

In view of, for example, minimizing the operating pressure of the reverse osmosis membrane modules M1, the supply pressure of the water to be treated applied by the high pressure pump P1 can be at or higher than the pressure necessary for the primary treatment and at or lower than the pressure necessary for the primary treatment and a subsequent treatment (secondary treatment) . On the other hand, the supply pressure on the concentrated water applied by each concentrated water pump P2 can be changed based on the subsequent treatment assigned to the second unit 20 equipped with that concentrated water pump P2. For example, in view of minimizing the operating pressure of the reverse osmosis membrane modules M2, the supply pressure can be at or higher than the pressure necessary for the subsequent treatment performed by those reverse osmosis membrane modules M2 and at or lower than the pressure necessary for the subsequent treatment performed by the reverse osmosis membrane modules M2 at the next stage.

According to the above-described reverse osmosis treatment apparatus 300 and reverse osmosis treatment method, the operating pressure of the reverse osmosis membrane modules M2 constituting each second unit 20 can be adjusted based on the subsequent treatment assigned to that second unit 20. In this way, the operating pressure can be kept at a low pressure near the reverse osmotic pressure necessary for the reverse osmosis treatment. This reduces the difference in pressure between the reverse osmosis membrane element on the outlet side in the downstream unit, at which the concentration has progressed, and the reverse osmosis membrane element on the inlet side in the upstream unit, at which concentration has not progressed much. Hence, local progression of the build-up of scale and the contamination of the reverse osmosis membranes are prevented.

Although the present invention has been described above, the present invention is not limited to the above-described embodiment and modifications, but various changes are possible without departing from the gist of the present invention. For example, the present invention is not necessarily limited to ones including all the components included in the above-described embodiment or any of the above-described modifications. It is possible to replace some of the components in the embodiment and the modifications with different components, add some of the components in the embodiment and the modifications to a different configuration, or omit some of the components in the embodiment and the modifications.

For example, although the first unit 10 includes five reverse osmosis membrane modules M1 in FIG. 1, the number of reverse osmosis membrane modules M1 included in the first unit 10 can any number not less than two. Moreover, although three second units 20 are provided and each second unit 20 includes two reverse osmosis membrane modules M2, four or more second units 20 can be provided and the number of reverse osmosis membrane modules M2 included in each second unit 20 can be any number not less than one.

In the case where the reverse osmosis treatment apparatus includes any numbers of reverse osmosis membrane modules M1, M2 and four or more second units 20, the number of reverse osmosis membrane modules M2 included in each of the plurality of second units 20 is the same so that the assignment of subsequent treatment can be switched. Moreover, the number of reverse osmosis membrane modules M1 included in the first unit 10 is larger than the number of reverse osmosis membrane modules M2 disposed per second unit 20 in a case of using reverse osmosis membrane modules M1 with the same specifications.

Also, in the case where the reverse osmosis treatment apparatus includes four or more second units 20, the subsequent treatments at the second and following stages are sequentially assigned to groups of one or more second units 20 arranged such that a more downstream one of the groups includes a smaller total number of reverse osmosis membrane modules M2 of the second units 20. For example, in a case of performing subsequent treatments at three stages through three second units 20, the subsequent treatment at the first stage (secondary treatment) is assigned to m second units 20 each including n reverse osmosis membrane modules M2, the subsequent treatment at the next stage (tertiary treatment) is assigned to less than m second units 20, and the subsequent treatment at the last stage (quaternary treatment) is assigned to further less than m second units 20.

Also, in the case where the reverse osmosis treatment apparatus includes four or more second units 20, the second concentrated water discharge pipes 22 of the plurality of second units 20 are connected to the concentrated water supply pipes 21 of the plurality of second units 20 through a plurality of lines each including the concentrated water return pipe 24, the return-pipe outlet valve V41, and the return-pipe inlet valve V42. By providing a plurality of lines each including the concentrated water return pipe 24, the return-pipe outlet valve V41, and the return-pipe inlet valve V42, the first concentrated water separated at the first unit 10 can be treated by subsequent treatments at three or more stages (up to a quaternary treatment or further) through three or more second units 20.

In the case where a plurality of lines each including the concentrated water return pipe 24, the return-pipe outlet valve V41, and the return-pipe inlet valve V42 are provided, the number of lines for each second concentrated water discharge pipe 22 may be N−1 or more if the number of stages for the subsequent treatments is set to N. As long as at least N−1 lines are connected to each second unit 20, the assignment of the subsequent treatments at the plurality of stages can be switched among the second units 20. Here, for each second unit 20, the return-pipe outlet valves V41 and the return-pipe inlet valves V42 may be installed as many as the number of lines provided for each second concentrated water discharge pipe 22. In addition to the second unit 20 that performs the subsequent treatment at the last stage, the second units 20 that perform the subsequent treatment at an intermediate stage may be switched among the plurality of second units 20.

The reverse osmosis membrane modules M1, constituting the first unit 10, and the reverse osmosis membrane modules M2, constituting the second units 20, may include pressure vessels 50 of the same type and reverse osmosis membrane elements 60 with the same specifications, or include different pressure vessels 50 and reverse osmosis membrane elements 60. Each of the reverse osmosis membranes 61 of the reverse osmosis membrane modules M1, M2 may be anyone of a reverse osmosis membrane and a nanofiltration membrane.

The reverse osmosis membrane modules M1, constituting the first unit 10, and the reverse osmosis membrane modules M2, constituting the second units 20, may include the same number of reverse osmosis membrane elements 60 housed per pressure vessel 50 or different numbers of reverse osmosis membrane elements 60 housed per pressure vessel 50. The number of reverse osmosis membrane elements 60 housed in each reverse osmosis membrane module M1, constituting the first unit 10, is preferably one to four and more preferably two to three, but is not particularly limited.

Reducing the number of reverse osmosis membrane elements 60 housed per pressure vessel 50 reduces the difference in pressure between the inlet side and the outlet side. However, doing so may require arranging many reverse osmosis membrane modules M1, M2 in parallel for the reverse osmosis treatment and increase the equipment cost. On the other hand, increasing the number of reverse osmosis membrane elements 60 housed per pressure vessel 50 eliminates the need for arranging many reverse osmosis membrane modules M1, M2 in parallel. However, doing so may increase the difference in pressure between the inlet side and the outlet side and shortens the usage life of the reverse osmosis membrane modules M1, M2 due to contamination of the reverse osmosis membranes 61. Thus, the number of reverse osmosis membrane elements 60 housed in each of the reverse osmosis membrane modules M1, constituting the first unit 10, and each of the reverse osmosis membrane modules M2, constituting the second units 20, can be set to an appropriate number based on the design and intended use of the reverse osmosis treatment apparatus.

1. A reverse osmosis treatment apparatus comprising:
a first unit including a plurality of parallel-arranged first reverse osmosis membrane modules that perform a primary treatment on water to be treated; and
a plurality of second units each including one or more parallel-arranged second reverse osmosis membrane modules that perform a subsequent treatment on concentrated water separated at the first unit,
wherein the second unit includes
a concentrated water supply pipe capable of supplying the concentrated water separated at the first unit to the second unit,
a concentrated water discharge pipe capable of discharging concentrated water separated at the second unit to outside of the reverse osmosis treatment apparatus,
a supply pipe valve capable of stopping the supply of the concentrated water through the concentrated water supply pipe, and
a discharge pipe valve capable of stopping the discharge of the concentrated water through the concentrated water discharge pipe, and
the concentrated water discharge pipes of the plurality of second units are connected to the concentrated water supply pipes of the plurality of second units through
a concentrated water return pipe capable of returning and re-supplying the concentrated water discharged from the second units to the second units, and
a return pipe valve capable of stopping the return of the concentrated water through the concentrated water return pipe.

2. The reverse osmosis treatment apparatus according to claim 1, wherein the concentrated water separated at the first unit is treated by subsequent treatments at two or more stages through the two or more second units.

3. The reverse osmosis treatment apparatus according to claim 2, wherein
the concentrated water discharge pipes of the plurality of second units are connected to the concentrated water supply pipes of the plurality of second units through a plurality of lines each including the concentrated water return pipe and the return pipe valve, and
the concentrated water separated at the first unit is treated by subsequent treatments at three or more stages through the three or more second units.

4. The reverse osmosis treatment apparatus according to claim 2, wherein the second unit that performs the subsequent treatment at the last stage among the subsequent treatments at the two or more stages is switched among the plurality of second units based on a cumulative time of the subsequent treatment, an integrated flow rate of concentrated water or permeated water, a transmembrane pressure in the second reverse osmosis membrane modules, or quality of the permeated water.

5. The reverse osmosis treatment apparatus according to claim 2, wherein the subsequent treatments at second and following stages are sequentially assigned to groups of the one or more second units arranged such that a more downstream one of the groups includes a smaller total number of the second reverse osmosis membrane modules.

6. The reverse osmosis treatment apparatus according to claim 2, wherein
each of the second units includes
a permeated water discharge pipe capable of discharging permeated water separated at the second unit to the outside of the reverse osmosis treatment apparatus, and
a permeated water flow rate adjustment valve that changes a flow rate of the permeated water to adjust a pressure inside the second reverse osmosis membrane modules, and
the pressure in the second reverse osmosis membrane modules of the second unit that performs the subsequent treatment at a stage preceding the last stage among the subsequent treatments at the two or more stages is adjusted by the permeated water flow rate adjustment valve.

7. A reverse osmosis treatment method for a reverse osmosis treatment apparatus including a first unit including a plurality of parallel-arranged first reverse osmosis membrane modules that perform a primary treatment on water to be treated; and a plurality of second units each including one or more parallel-arranged second reverse osmosis membrane modules that perform a subsequent treatment on concentrated water separated at the first unit, the reverse osmosis treatment method comprising:
supplying the concentrated water separated at the first unit to some second units among the plurality of second units to thereby perform a subsequent treatment on the concentrated water;
returning the concentrated water separated at the second units having performed the subsequent treatment to a remaining second unit among the plurality of second units to thereby perform a further subsequent treatment on the concentrated water;
performing the subsequent treatments on the concentrated water separated at the first unit at two or more stages through the plurality of second units; and
performing reverse osmosis treatment on the water to be treated while switching the second unit that performs the subsequent treatment at the last stage among the plurality of second units.
